(19) United States
(12) Patent Application Publication
(10) Pub. No.: US 2014/0065406 A1
(43) Pub. Date: Mar. 6, 2014

(54) OXYGEN BARRIER FOR PACKAGING APPLICATIONS

(71) Applicants: Lars Berglund, Akersberga (SE); Qi Zhou, Taby (SE); Joby Jose Kochumalayyil, Kista (SE)

(72) Inventors: Lars Berglund, Akersberga (SE); Qi Zhou, Taby (SE); Joby Jose Kochumalayyil, Kista (SE)

(73) Assignee: KTH Holding AB, Stockholm (SE)

(21) Appl. No.: 14/115,163

(22) PCT Filed: May 4, 2012
(86) PCT No.: PCT/SE2012/050470

§ 371 Date: Nov. 1, 2013

(30) Foreign Application Priority Data
May 4, 2011 (SE) 1150388-5

(51) Int. Cl. C09D 105/14

(52) U.S. Cl. CPC C09D 105/14
USPC 428/221; 428/454; 428/452; 428/375; 427/299; 427/369; 427/355; 427/358; 427/359; 106/217.9

(57) ABSTRACT

The present invention relates to composite material of xyloglucan and clay for use as a coating material. The invention also relates to a method of producing the coating.

### FIELD OF TECHNOLOGY

The present invention relates to a barrier for packaging applications and a method of applying the barrier.

### BACKGROUND TO THE INVENTION

The ingress of oxygen through food packages is the main cause for food deterioration owing to the oxidation of fats and oils and the growth of aerobic microorganisms and molds in presence of oxygen.¹ For prolonged shelf-life of food products, it is necessary to resort to packaging materials that balance barrier properties with suitability for the package shape and structure. Such a balance is often not achieved by the use of a single packaging material. Typical food packaging structures are generally composed of several layers in order to meet different requirements such as mechanical strength, gas and aroma barrier properties, thermal stability, adhesiveness and cost efficiency. In many cases the barrier layer is the most critical and represents the highest fraction of the total cost. The traditional barrier layer has been aluminium foil with its obvious disadvantages of opacity and non-renewability. Layers of barrier polymers such as poly(vinylidine chloride) (PVDC), poly(ethylene vinyl alcohol) (EVOH), poly(vinyl alcohol) (PVOH) and polyamide (PA) are available but all have drawbacks in terms of environmental/carbon footprint or high cost.

Bio-based materials have been explored recently to develop barrier films to extend shelf life and improve quality of food while reducing the dependency on conventional polymers.²⁻⁴ The latest addition to these materials are hemicelluloses, especially wood hemicelluloses and have been studied recently as oxygen barrier films.⁵⁻⁷ However, the use of such biodegradable polymers has been limited because of problems related to properties such as brittleness, poor gas and moisture barrier, processability and cost effectiveness. For instance, wood hemicelluloses have limited film-forming ability and extraction from raw materials is tedious whereas other widely used biopolymers such as starch and polylactic acid (PLA) have low oxygen barrier performance.

The effectiveness of highly polar polymers such as those containing hydroxyl groups (PVOH or hemicelluloses) as oxygen barriers becomes reduced or even vanish when the polymer is exposed to high humidity atmosphere. During the last few years the use of a nanocomposite concept has proven to be a promising option in order to improve mechanical and barrier properties.⁹⁻¹³ With small amounts of montmorillonite clay (MMT) added, it is possible to obtain improvements in polymer nanocomposites in terms of elastic modulus, tensile strength, gas-barrier properties, and reduced rate of water absorption. In packaging solutions the most widely explored composite is prepared from biopolymers such as starch and polylactic acid (PLA) and montmorillonite clay.^{2, 14-18} Particularly interesting materials are starch-based nanocomposites with improved mechanical strength and lower water transmission rate.¹⁸ However, there are many problems in achieving starch nanocomposites with desired properties for packaging applications, especially in terms of gas-barrier performance. In the preparation of nanocomposites based on plasticized starch, the most important hindrance is the plasticizer intercalation in the layered structure of MMT instead of starch macromolecules. ¹⁸⁻²⁰ The results in terms of nanocomposite properties are disappointing for MMT bionanocomposites. The reason is poor dispersion of MMT, lack of nanostructural order and an MMT content of typically only 5 wt % or lower.

For nacre-mimetic composites based on polyelectrolytes moisture durability is a problem. Previous reports have shown substantial degradation of mechanical properties at high relative humidity. Polymer-clay interfaces where ionic interactions contribute to interfacial adhesion are sensitive to moist environments since water may interfere with polymer-clay interactions.

Williams et al. (Metal Materials and Processes, 2005, 17, p. 289-298) describes xyluglucan-clay composites with and without glycerol as plasticizer where the clay is kaolinite, brucite and layered double hydroxide. The aim of the study is though to study the effect of glycerol on intercalation, the study does not mention the effect of clay on permeability and/or mechanical properties.

### SUMMARY OF THE INVENTION

There is a need for a water-soluble biological polymer, which interacts strongly with MMT surface also in an environment of high relative humidity.

The present invention has the objective to seek alternatives to synthetic polymers and/or aluminium as barrier layers in packaging applications. As previously stated, the interesting oxygen barrier property of wood hemicelluloses is eclipsed with the brittleness without adding plasticizers or blending with compatible polymers such as carboxymethyl cellulose or alginate. In fact, none of the reported literature on oxygen barrier properties of hemicelluloses mentions the oxygen permeability of the native hemicellulose.⁵ Previous work has shown that the hemicellulose xyloglucan (XG) extracted from tamarind seed has good film-forming and mechanical properties without plasticizer being added.⁸

One aspect of the present invention relates to a coating comprising a layer of a film comprising xyloglucan and clay.

In one embodiment of the present invention the clay is sodium-montmorillonite (MMT).

In another embodiment the clay content is 1 to 20 wt %, for example 2, 5, 10 or 15 wt %.

In another embodiment in the clay content is 10 wt %.

In another embodiment the sheets of the clay are oriented substantially parallel with the film.

In yet another embodiment the film does not comprise a plasticizer. In yet another embodiment the film consists of xyloglucan and clay.

In another embodiment the coating comprises two or more layers of the film.

Another aspect of the present invention relates to a paperboard comprising the coating described above.

Another aspect of the present invention relates to a moulded fiber product comprising the coating described above.

Another aspect relates to a polymeric material comprising the coating described above.

One embodiment relates to a coated polymeric material wherein the polymer is a polyester and in another embodiment the polymer is an oriented polyester.

Another aspect of the present invention relates to a film comprising xyloglucan and 20 wt % of clay.

Another aspect of the present invention relates to a method of coating a substrate with the coating as described above comprising the steps:
a) Providing a substrate;
b) Optionally activating the surface of the substrate;
c) Providing a dispersion of xyloglucan and clay;
d) Applying the dispersion to the substrate;
e) Spreading the dispersion across the substrate by applying a shear force to the dispersion;
f) Optionally, applying pressure to the applied dispersion; and
g) Drying the coating;
h) Optionally repeating the steps d to g.

In one embodiment the spreading is done using a knife, rod, blade or a wire.

A yet another aspect relates to a coating obtainable by the method.

A yet another aspect relates to the use of the coating or the film in packaging material.

A yet another aspect relates to the use of the coating or the film as a barrier material, preferably for food packaging applications.

A yet another aspect relates to the use of the coating or the film as an oxygen barrier material, preferably for food packaging applications

### BRIEF DESCRIPTION OF THE FIGURES

FIG. 1: Schematic representation of xyloglucan/nanocomposite coating on OPET film

FIG. 2: X-ray diffraction pattern of xyloglucan-Na-MMT hybrid

FIG. 3: TEM micrograph of the cross-section of xyloglucan-Na-MMT nanocornposite containing 10 wt % of Na-MMT showing the coherent stacking of silicate layers as alternating dark lines

FIG. 4: Representative SEM images of a nanocomposite containing 10 wt % MMT in xyloglucan matrix

FIG. 5: Typical stress- strain curves of XG-clay films conditioned at 50% RH and 23° C. The MMT clay content in wt % is presented beside the curves.

FIG. 6: (A) Relative storage modulus of xyloglucan nanocomposites with native xyloglucan (B) Tan δ behavior of xyloglucan/Na-MMT hybrids

FIG. 7: (A) Effect of MMT content on the TGA curve of xyloglucan-MMT nanocomposites. (B) Effect of MMT contents on the temperature at which 60% of weight is lost from TGA curve of xyloglucan-MMT nanocomposites.

FIG. 8: MMT sheet orientation (A) complete exfoliation and dispersion (B) incomplete exfoliation with increasing intercalation.

FIG. 9: Schematic process steps for coating xyloglucan MMT nanocomposites onto substrates for achieving low oxygen transmission rate.

FIG. 10: Light transmittance of xyloglucan-MMT nanocomposites coated over OPET film

FIG. 11: Oxygen transmission rate of XG/MMT composite films coated over OPET film in comparison with OPET film (cc/[m².day])

FIG. 12: Cross-sectional view of xyloglucan-clay composites (10 wt % MMT) coated over OPET film as observed in SEM.

FIG. 13: Comparison of calculated relative permeability with experimental data of xyloglucan-MMT nanocomposites as a function of MMT concentration at 23° C. and 0% RH. The red line represents the experimental data. The calculated fits based on L=425 nm and W=1 nm.

FIG. 14: Oxygen transmission rate of XG/MMT composite coated over paper board and PLA film at 50% RH and 23° C. (cc/[m².day])

FIG. 15: (A) Representative SEM images of a nanocomposite containing 10 wt % MMT in xyloglucan matrix, (B) X-ray diffraction pattern of Xyloglucan-MMT hybrid. The interlayer or gallery distance between the stacked layers for MMT was around 9.8 Å (C) TEM micrograph of the cross-section of xyloglucan-MMT nanocornposite containing 10 wt % of MMT showing the coherent stacking of silicate layers as alternating dark lines, (D) Schematic representation of monolayer of xyloglucan adsorbed on MMT faces and the distance between the MMT platelets, (E) Schematic picture of Xyloglucan molecule modeled as a cylinder between two MMT platelets. The Xyloglucan radius is denoted R and the distance D is assumed to be the distance between a hydroxyl group on the MMT surface and its hydrogen bonding partner within the Xyloglucan molecule.

FIG. 16: modulus is presented as a function of Vf for XG/MMT bionanocomposites. In model predictions (“Model”) are presented based on the rule of mixtures E=Ep Vp+Em Vm.

FIG. 17: a) Storage modulus of XG/MMT composites with various MMT contents, b) Tan δ of xyloglucan nanocomposites as a function of temperature.

### DETAILED DESCRIPTION OF THE INVENTION

The objective of the present study is to develop a green concept for high-performance clay-biopolymer nanocomposites based on oriented clay platelets. The processing concept should be continuous in order to facilitate scaling up, and preferably optical transparency as well as improved mechanical and gas barrier properties, also under moist conditions. The strategy to achieve this with a water-soluble biological polymer is to rely on non-electrostatic interactions between the clay and the XG biopolymer. Layered bionanocomposite coatings with strong MMT in-plane orientation are for the first time prepared by continuous water-based processing.

Therefore the present invention relates to a film with improved mechanical and oxygen barrier performance, especially at high relative humidity (RH) atmosphere, of a tamarind seed xyloglucan. Xyloglucan (XG) used in the present invention has definite advantages when preparing the nanocomposites since it does not require any plasticizer to form good films.

It should be noted that embodiments and/or features and/or advantages described in the context of one of the aspects and/or embodiments of the present invention may also apply mutatis mutandis to all the other aspects and/or embodiments of the invention. For example the clay content described in connection with one aspect/embodiment may naturally also apply mutatis mutandis in the context of other aspects/embodiments of the invention, all in accordance with the present invention per se.

The term “xyloglucan” shall be understood to pertain to non-starch polysaccharides composed of a beta(1→4)-linked glucan backbone substituted with alfa (1→6)-linked xylose, which is partially substituted by beta(1→2)-linked galactosyl residues. The xyloglucan polymers, in the context of the present invention, may derive from seeds of the brown pod-like fruits from the tamarind tree (Tamarindus indica) or from fluor obtained from for example Detarium snegalense, Afzelia Africana and Jatoba. The xyloglucan polymer is soluble in water, yielding a highly viscous solution.

The term “clay” as used in the present invention shall be understood to pertain phyllosilicates or sheet silicates and include but is not limited to sodium-montmorillonite, kaolinite, chlorite and mica.

The aim of the invention is to enhance the oxygen barrier property of xyloglucan at high humidity atmosphere by creating a nanocomposite with layered sodium-montmorillonite (MMT). This increases the diffusion path for the oxygen molecules (tortuosity) in the nanocomposite and hence lowers oxygen transmission rate. Two different strategies of forming the film are evaluated herein—1) solvent casting of freestanding films from water solution and 2) a coating procedure. The coatings were made on different substrates to evaluate oxygen barrier performance of the xyloglucan nanocomposite in industrially viable cases.

In specific industrial coating application it can be advantageous of having XG of lower molecular weight as defined above. Native XG has a high molecular weight of the order of 1-2MDa. This makes the solution highly viscous. It is hence difficult to prepare an XG solution with more than 5wt % solid content. The addition of clay makes the solution even more viscous. Commercial coatings are required to have a coating of 10 g/m². This roughly corresponds to a solid concentration of the dispersion of 10%. With for example 4-5% of solid content in XG or XG nanocomposites, the area density of the coating achieved would be <6 g/m². To reach the optimal value, the viscosity of the solution should be reduced and one possible way is by reducing the molecular weight of the XG. Since it has been found that even with reduced molecular weight, XG strongly adsorbs to clay surface points to the fact that clay can still be used to make up the properties of low molecular weight XGs and thereby a high area density of the coating could be achieved.

In one embodiment the molecular weight of the xyloglucan is at least 10000 g/mol or more, or 30000 g/mol or more, or 50000 g/mol or more, or 100000 g/mol or more. The composite could also comprise a mixture of xyloglucans having different molecular weights or a distribution of molecular weights. A preferred range of molecular weights are 10,000 to 500,0000 g/mol, or more preferably 30,000 to 500,000 g/mol or more preferably 100,000 to 300,000 g/mol.

When using polymers of lower molecular weight a plasticizer can be added. In a preferred embodiment the present invention does not contain any plasticizer.

In another embodiment the clay content is 1 to 30 wt %, for example 1 wt % or more, or 3 wt % or more, or 5 wt % or more, or 10 wt % or more, or 30 wt % or less, or 25 wt % or less or 20 wt % or less, or 15 wt % or less, or 12 wt % or less. In one embodiment the content is 10-20 wt %. Since brittleness may be a problem for nacre-mimetic nanocomposites of high MMT volume fraction, one embodiment of the present invention relates to volume fractions up to 0.1 in order to provide potential for high ductility (strain-to-failure). For example a volume fraction of 0.1 or less, or 0.08 or less, or 0.05 or less, or 0.01 or less, but more than 0.0001, or 0.001 or more.

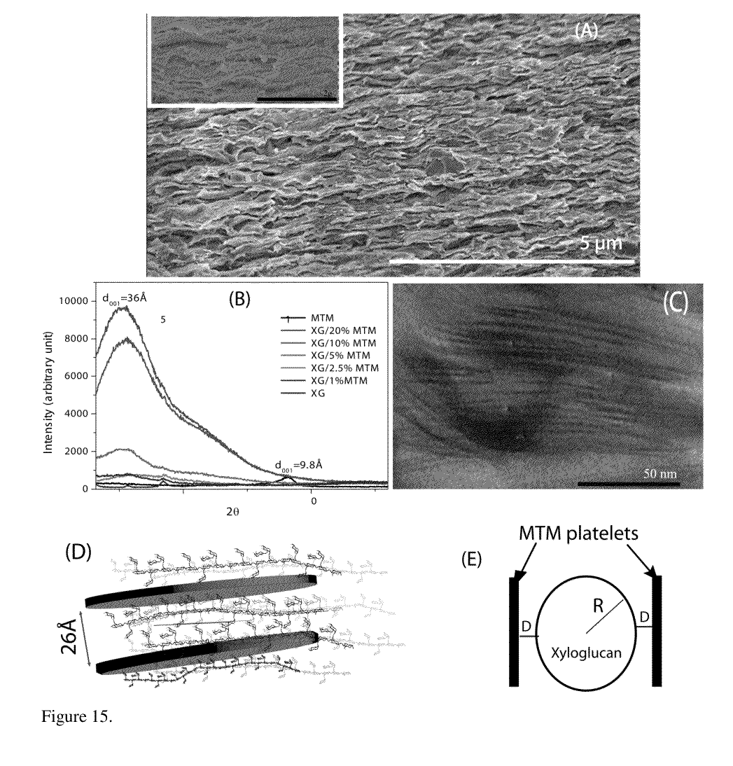

Coatings with MMT content as high as 20% by dry weight (approx. 12 vol %) and high optical transparency were cast successfully from MMT-XG suspensions. SEM images, (FIG. 15(A) of the cross-section of a sample with 10 wt % MMT reveal strong in-plane orientation of the platelets. Images of an MMT-rich region, see 15(C), reveals a layered structure conceptually similar to the high clay content multi-layered structures prepared by LbL assembly or papermaking approaches. These observations of strong in-plane orientation are unexpected for solvent cast free-standing films and different from what is typical for bionanocomposites

A dramatic reduction in oxygen transmission rate occurs when applying the xyloglucan-MMT nanocomposites as coatings on substrates. The coating thickness was typically 1-4 μm, for example 1 μm or more, or 2 μm or more, or 3 μm or more, or 4 μm or less. In this method the xyloglucan-MMT nanocomposites are coated on substrates using a dispersion coating process, or similar process known to the skilled in the art. This may be followed by a constraining/structuring step where the flow of the applied xyloglucan-MMT is restricted with a knife, metal rod or similar. This may form strong inertial forces that create both shear and elongational fields in the dispersion. These shear and stretching gradients cause preferential alignment of the clay platelets. The stretched (or deformed) polymer chains are then preferably subsequently rapidly collapsed under a high temperature when water is evaporated and the favorable structure of the inorganic platelets in the matrix is set. This process results in more favorable xyloglucan-MMT nanocomposite arrangement for restricting the gas diffusion. The scheme of this approach is illustrated below and according to FIG. 9.

One method of preparing the nanocomposite comprises the following steps. First, a suspension of completely exfoliated MMT platelets is mixed with an XG solution. XG is then expected to adsorb on MMT platelet surfaces. A suspension of XG coated MMT platelets in XG solution is obtained, since there is a substantial excess of XG. Freestanding MMT-XG nanocomposite films may then be casted on for example a PTFE surface with sidewalls. For oxygen transmission rate and optical transparency measurements, nanocomposite solutions may be prepared in the same manner and coated on an oriented polyester terphtalate (OPET) film.

Referring now to FIG. 9. In step A the xyloglucan-nanoclay dispersion or similar is applied onto a substrate such as paperboard or another polymer. The clay platelets are then in arrangement A′ which is not optimally aligned and positioned to prevent oxygen transmission. In step B preferential alignment of the clay platelets occurs as a result of the shear force applied when the flow is restricted by e.g. a wire rod or knife (blade). In step C collapse of the structure occurs as a result of the heating and evaporation of water to form the xyloglucan-clay nanocomposite where the clay platelets are in more favorable arrangement C′. Here in C′ the clay platelets are arranged parallel to the film surface and the MMT tactoids are more separated laterally than in A′ offering a larger tortuosity path to oxygen diffusion. This process could also be used for making films of xyloglucan and clay, preferably on a surface where xyloglucan is easily adhered to, for instance a hydrophilic substrate film. The alignment could be studied using TEM or SEM.

Dispersion coating is a preferred method for applying xyloglucan nanocomposite on substrates, especially in packaging applications, but other application methods are also envisaged. Standard industrial machinery/process used in the paper and packaging industry has successfully been used such as comma coaters, wire road coaters and stainless steel gap applicators (as used in the examples below) but the scope of the present invention is not to be limited to those but also encompasses other coating procedures that results in a restrained and constrained flow and resulting shear stresses which causes preferential alignment of clay platelets.

Films may also be formed by evaporating the solvent and may be carried out by using film casting, solvent casting.

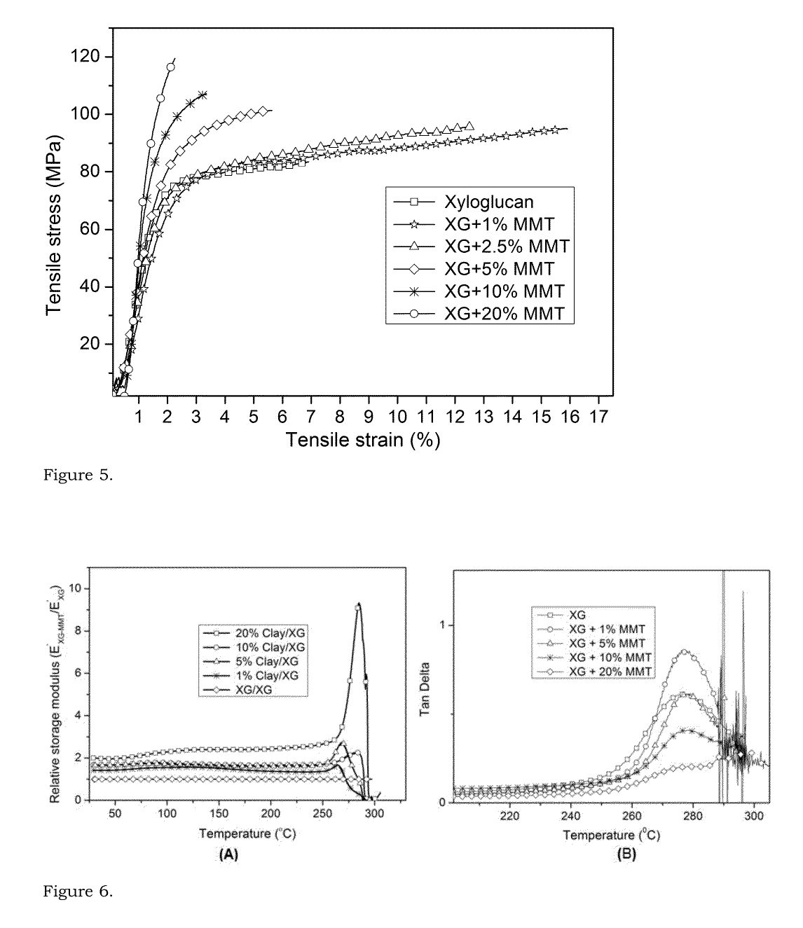

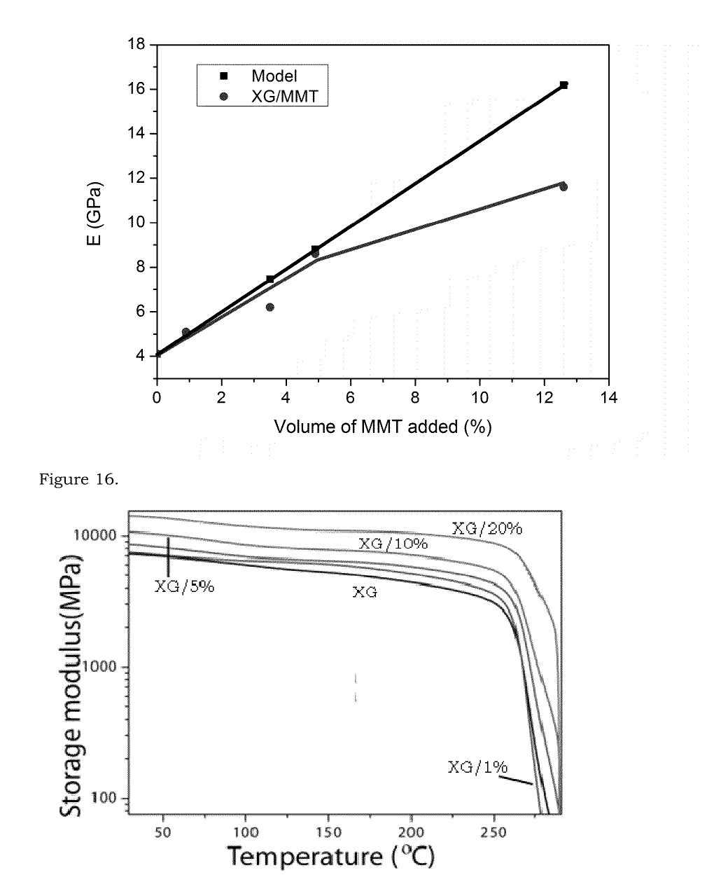

The tensile properties of the composites showed remarkable improvements for XG/MMT nanocomposites (see FIG. 5 and Table 2. The tensile strength increased from 92 MPa for native XG to 123 MPa with 20 wt % MMT (12 vol %). For most MMT nanocomposites in the literature, excluding nacre-mimetic ones with much higher clay content, high inorganic content leads to reduced strength. There is a remarkable three-fold increase in XG/MMT modulus for the same composition. At less than half the MMT content, the present modulus reaches the same level as nanocomposites with more than 50 wt % MMT in PVA or polyelectrolyte matrices prepared by LbL technique. This shows that the present XG/MMT bionanocomposite has high reinforcement efficiency. In FIG. 16, E is plotted versus Vf and the predicted line “model” is close to data until Vf=5%. In model predictions (“Model”) are presented based on the rule of mixtures

E=Ep Vp+Em Vm

Where E is composite modulus in-the-plane, EMMT is clay platelet modulus, Vf is volume fraction, EXG is XG modulus and Vm is volume fraction of polymer matrix. It is assumed that all platelets are oriented in the loading direction, that interfacial platelet-matrix adhesion is perfect, and that Em is x GPa. Ep is obtained as 100 GPa by an approximate fitting to data. The purpose is to use the value for Ep obtained by fitting as a measure of reinforcement efficiency. Ep for a given material system will depend on orientation distribution, interfacial adhesion, and the extent of agglomeration. For the sake of the argument, we assume that interfacial adhesion is perfect. If each individual platelet is discrete, then the reinforcement efficiency will be high since each platelet is surrounded by matrix and this ensures efficient load transfer compared with the case when platelets are stacked without matrix in between. The TEM images in Figure S1 show some waviness in platelet organization and demonstrate that the real orientation distribution deviates from the ideal. At a volume fraction of 0.12, the reinforcement efficiency is lower, possibly because a larger extent of agglomeration at higher Vf.

The effective MMT modulus E_{MMTeff} defined above can be used as a measure of reinforcement efficiency and is 100 GPa. If a similar approach is applied to literature data, one can conclude that the present value is the highest E_{MMTeff} obtained for biopolymers. Strong MMT-matrix interaction, little MMT aggregation and strong in-plane orientation distribution are contributing factors. Note in Table 2 that even at 20 wt % MMT content, many samples showed higher strain-to-failure (around 2%) than is typically observed for the higher volume fraction nacre-type of materials. The higher matrix content in the present materials improves ductility, and this also indicates good dispersion of the MMT platelets since agglomerates will initiate failure at low strains.

TABLE 2
Tensile properties of xyloglucan nanocomposites at 50% RH and 23° C.

| | Tensile strength, | Tensile strain | Elastic modulus, |
|---|---|---|---|
| Sample | MPa | at break, % | GPa |
| Xyloglucan | 92.9 ± 5.8 | 8.9 ± 2.0 | 4.1 ± 0.15 |
| XG + 1% MMT | 89.1 ± 6.9 | 15.5 ± 2.9 | 5.1 ± 0.53 |
| XG + 2.5% MMT | 96.2 ± 6.7 | 12.2 ± 1.7 | 5.9 ± 0.1 |
| XG + 5% MMT | 103.9 ± 2.7 | 6.6 ± 1.9 | 6.2 ± 0.48 |
| XG + 10% MMT | 114.3 ± 6.3 | 3.8 ± 1.2 | 8.6 ± 0.26 |
| XG + 20% MMT | 123 ± 7.4 | 2.1 ± 0.31 | 11.6 ± 1.7 |

The mechanical properties of the XG/MMT composites of the present invention disclose properties as nacre-mimetic composites of substantially higher clay content. The composites of the present invention have far better mechanical properties than conventional bionanocomposites based on starch, PLA and PCL. Even the nanocomposites tailored with synthetic polymers are inferior to XG/MMT. Again, strong in-plane orientation, low extent of agglomeration and strong interfacial interaction are likely explanations. Polysaccharides often show poor mechanical performance at high relative humidity. Starch is a well-known example. In Table 3, mechanical properties at 92% RH are also reported. Even in this rather severe environment, roughly half the strength and modulus or more are preserved. The excellent mechanical properties of XG-clay nanocomposites rely on strong molecular interaction between the matrix polymer and the inorganic reinforcement, even in the moist state, so that stress can be efficiently transferred from the matrix to the stiffer MMT platelets.

In one embodiment the present invention relates to a composite having an elastic modulus of 5 GPa or more, or 6 GPa or more, or 8 GPa or more, or 10 GPa or more when measured at 50% RH at 23° C. In another embodiment the composite of the present invention has a tensile strength of 85 MPa or more, or 90 MPa or more, or 95 MPa or more, or 100 MPa or more, or 110 MPa or more, or 120 MPa or more when measured at 50% RH at 23° C. In another embodiment the composite of the present invention has an elastic modulus of 4 GPa or more or 5 GPa or more, or 6 GPa or more when measured at 92% RH at 23° C. In another embodiment the present invention relates to composites having a tensile strength of 60 MPa or more, or 70 MPa or more or, 80 MPa or more when measured at 92% RH at 23° C.

TABLE 3
Tensile properties of XG/MMT nanocomposites films
conditioned at 92% RH and measured at 23° C.

| | Tensile strength | Modulus | Strain-to- |
|---|---|---|---|
| Sample | (MPa) | (GPa) | failure (%) |
| XG/20 wt % MMT | 81 ± 2.3 | 6.8 ± 1.6 | 3.0 ± 0.46 |
| XG/10 wt % MMT | 63 ± 5.2 | 4.1 ± 0.14 | 6.4 ± 2.1 |
| XG | 56 ± 6.1 | 3.0 ± 0.14 | 9.9 ± 5.2 |

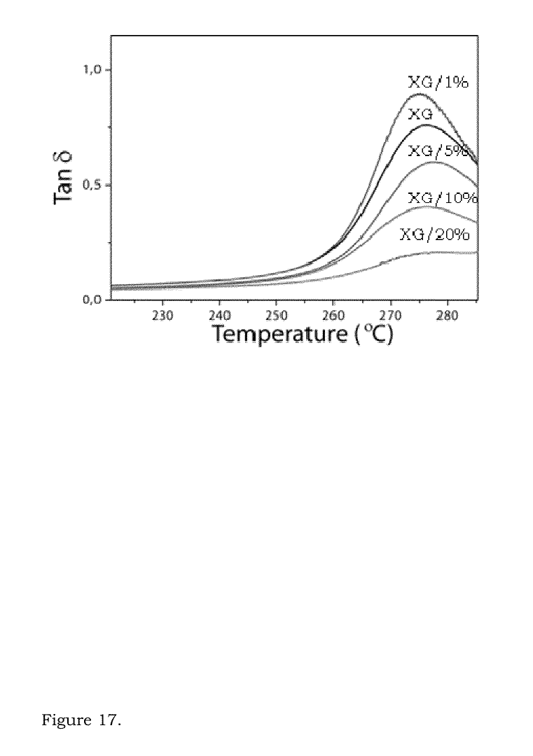

The composites of the present invention also disclose very good thermal stability. The thermo-mechanical properties of native XG and nanocomposites prepared with MMT are presented in FIG. 17. The storage modulus is increased significantly in the glassy state. The softening slope around the Tg of XG is decreased with increasing XG content.

The unique mechanical properties noticed with xyloglucan are complemented with the excellent oxygen barrier property of the material disclosed herein. Xyloglucan-MMT nanocomposites were successfully prepared with unique properties compared to any other polysaccharide-clay nanocomposites reported. Besides the enhancement of the mechanical properties, the resulting biopolymer—clay films also exhibit higher thermal stability and improved gas-barrier properties even at high humidity atmosphere that allow their immediate application in food packaging. The nanocomposites can be applied by a dispersion coating on many substrates including paper board which opens the way for introducing the barrier layer as part of a standard coating operation during a packaging manufacture. This reduces the requirements of the synthetic polymer to the provision of a barrier to moisture loss and protection of the food from external contamination.

An interesting application of XG/MMT films could be as environmentally friendly replacement of aluminium barriers in liquid packaging. The oxygen permeability at 80% RH is then of particular interest, since polysaccharides typically fail to perform under these conditions. In Table 4, it is apparent that the XG/MMT composition with 20 wt % MMT has an oxygen permeability of only 1.44 cc μm m⁻² d⁻¹ kPa⁻¹. Since inorganic coatings suffer from pin holes and can have higher values, the present data are encouraging, and indicate that XG/MMT may be of interest as barrier films or coatings with low values for embedded energy and based on renewable resources (tamarind seed waste products from the food industry).

TABLE 4
Oxygen permeability of XG/MMT nanocomposite
films (cc · μm/[m2 · day]kPa−1)

| | | XG + | XG + | XG + |
|---|---|---|---|---|
| Condition | XG | 4.3% MMT | 8.9% MMT | 20% MMT |
| 0% RH, | 0.02 ± 0.00 | 0.01 ± 0.00 | 0.00 ± 0.00 | 0.00 ± 0.00 |
| 23 ° C. | | | | |
| 50% RH, | 0.45 ± 0.00 | 0.18 ± 0.01 | 0.04 ± 0.00 | 0.05 ± 0.00 |
| 23 ° C. | | | | |
| 80% RH, | — | 30.1 ± 0.01 | 6.03 ± 0.02 | 1.44 ± 0.00 |
| 23 ° C. | | | | |

In one embodiment the present invention relates to composites having an oxygen permeability of 0.3 or less, or 0.2 or less, or 0.15 or less, or 0.10 or less , or 0.05 or less when measured at 50% RH at 23° C. In another embodiment the invention relates to composites having an oxygen permeability of 40 or less, or 30 or less, or 20 or less, or 10 or less, or 5 or less when measured at 80% RH at 23° C. Oxygen permeability measured in cc.μm/[m2.day]kPa−1.

An interesting feature of XG/MMT nanocomposites is the ease by which it was possible to coat the material on different substrate films. A representative xyloglucan-MMT nanocomposite solution containing 10 wt % MMT was successfully coated on paperboard as well as on PLA films. In the case of paperboard with a single layer coating, there was 85% reduction in oxygen transmission rate and with a double layer of XG-MMT coating, a reduction of 99% in oxygen transmission was observed. For PLA, there is more than 95% decrease in oxygen transmission rate with two thin layers of xyloglucan nanocomposite coating.

The composites of the present invention also disclose a lower moisture uptake compared to for example native polysaccharide. It was observed that with 20 wt % of MMT addition, the moisture uptake of XG/MMT is about 25% lower by weight compared with neat XG. If the higher inorganic content is taken into account, there is also an effect of about 8% lower moisture uptake for XG as a composite matrix compared with XG in a neat polymer film. Again, it is possible that the considerable volume of XG present close to MTM surfaces may have reduced moisture adsorption. This observation also indicates that there is no concentration of moisture at the XG/MTM interfacial region. The XG/MTM interaction appears favourable also under moist conditions.

Compared with earlier studies of clay bionanocomposites, MMT/XG shows much higher mechanical properties, better optical transparency and much better barrier properties at comparable clay content. The material therefore occupies new property space. In contrast to in-plane oriented MMT/polyelectrolyte nanocomposites, favourable oxygen barrier and mechanical properties are observed at high relative humidity. This improvement might rely on the strong physical adsorption of XG to MMT in wet condition.

The present invention will be further disclosed and discussed in the following examples.

### EXAMPLES

### Materials and Methods

Preparation of xyloglucan-MMT (XG/MMT) nanocomposite films: 1% MMT (Cloisite Na+, density of 2.86 g/cc, Southern Clay Products, Inc.) solution was prepared by using Ultra Turrax mixer (IKA, DI25 Basic) at 25000 rpm for 15 min followed by sonication using Vibra-Cell (Sonics & Materials, Inc.) ultrasonic processor at 37% amplitude at ambient temperature. It was repeated several times and the resultant solution was kept undisturbed for three days and any clay aggregates were removed. The industrially available xyloglucan (weight average molecular mass, 2.5 MDa, lnnovassynth technologies Ltd., India) was purified by centrifugation (4000 rpm for 45 min.) and freeze dried to obtain pure xyloglucan. Clay dispersions of 1.0, 2.0, 5.0, 10.0, and 20.0% (wt/wt) were added to the corresponding XG solutions and mixed with Ultra thorax at 13500 rpm for 15 min. and kept under magnetic stirring overnight. The resulting solution was centrifuged at 4000 rpm for 20 min. to remove micro bubbles and any clay aggregates remaining. The final solution was concentrated to the desired viscosity to avoid leaking problems at the knife edge of the coater. The final solid contents of different nanocomposite solutions were in the range of 4-5%. The resulting solutions were evenly spread over a Teflon® mold and dried under constrained condition in an oven at 40° C. overnight. The constrained conditions were implemented since when a xyloglucan-clay dispersion is casted in a Teflon mold as a free-standing film or coated on a substrate, the film will shrink as a result of solvent evaporation. To prevent this, the dispersion was made to adhere to rough surfaces at the outer sides of the film. The films were peeled off from the Teflon® surface for further characterization. The thickness of the films was in the range of 10-15 μm.

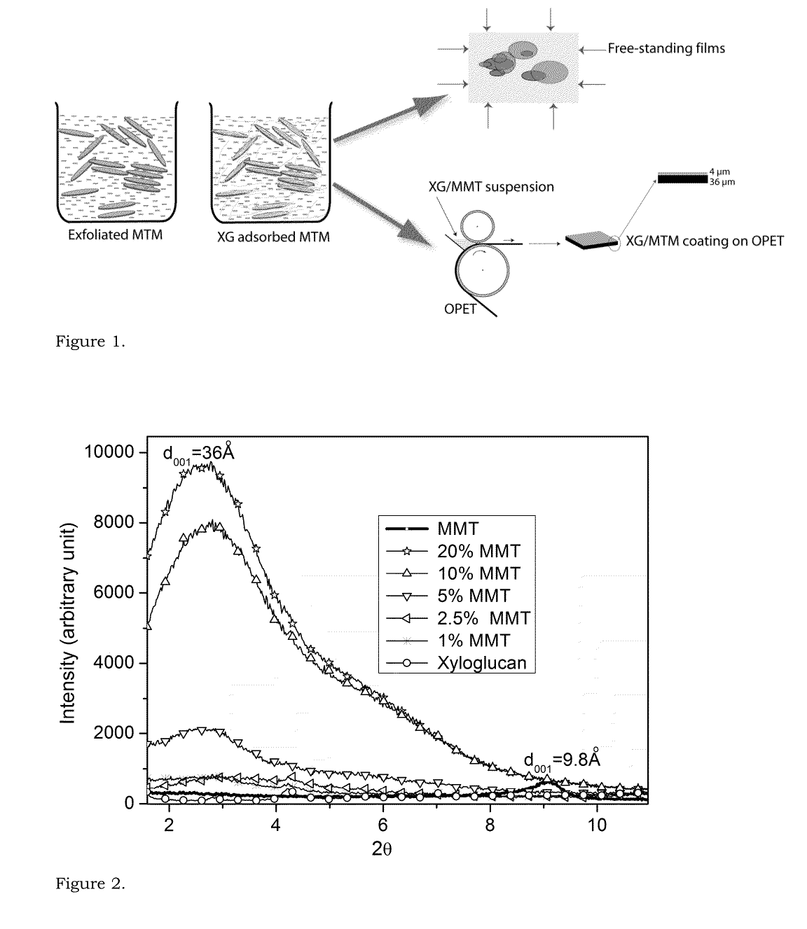

Dispersion coating on substrates: Different xyloglucan MMT nanocomposite solutions with appropriate viscosity were coated on an oriented polyester film (OPET) in a comma coater (Hirano Tecseed Co., Ltd., Japan) where the OPET film was rolling at a speed of 0.5 meter/min (see FIG. 1). The film with wet coating was immediately dried in a heating chamber kept at 120° C.

The thicknesses of the wet coatings were adjusted in such a way that the final thickness of the dried films was 4 μm. The reason for using the OPET film was its oxygen permeability which remains almost unchanged at different relative humidity levels. In the coating process on OPET film the constrained conditions on the film come from the tension between the rolls in the heating chamber which provides the necessary strain to avoid shrinkage of the film

Coatings on paper boards were also made using a wire-rod coater (model 202, K Control coater, R K Print-Coat Instruments Ltd., UK) with wire diameter 1.27 mm that deposits a wet coating of 100 μm thicknesses. A representative nanocomposite composition containing 10 wt % MMT was used. The coating was dried under constrained condition at 120° C. for 15 min in an oven. A second coating of xyloglucan nanocomposite was deposited on the dried first xyloglucan nanocomposite layer and subsequently dried in the same manner.

For coating on hydrophobic PLA film, the surface of the PLA film was made hydrophilic using oxygen plasma treatment (Plasmalab 80 Plus, Oxford Instruments, UK) and then the xyloglucan and nanocomposite solution (containing 10 wt % MMT) were coated using a stainless steel gap applicator (R K Print-Coat Instruments Ltd., UK) with a gap size of 60 μm.

The drying/heating step of the xyloglucan MMT nanocomposite serves to evaporate the solvent and to create a structure in the film. Depending on the melting/decompostion temperature of the substrate and the xyloglucan MMT nanocomposite, the temperature could be between room temperature and degradation temperature/melting temperature of the substrate and xyloglucan MMT nanocomposite. The degradation temperature of Xyloglucan is >260° C. so a range of temperatures are possible. The drying time depends on the thickness of the wet film deposited and the temperature. In most examples 120° C. for 15 min was used but higher temperatures can be used if needing to reduce time in process.

Oxygen permeability measurements: Oxygen transmission of films was measured using a Mocon Ox-tran 2/21 (Modern Controls Inc., Minneapolis, USA) with an oxygen sensor that conforms to ASTM D-3985 standard. The area of free-standing films was 5 cm². In the case of coated substrates, the OTR measurements were carried out on the coating side and the measurement area was 50 cm².

Light transmittance: Light transmittance of the coatings over OPET films was measured from 400 to 600 nm using a Hitachi U-3010 spectrophotometer, and was correlated based on the film thicknesses using the Lambert-Beer's law.

X-ray Diffraction: Diffractograms were recorded in reflection mode in the angular range of 0.5-15° (2θ). The measurements were done with an X'Pert Pro diffractometer (model PW 3040/60). The CuKa radiation (1.5418 Å) generated with a tension of 45 kV and current 35 mA is monochromatized using a 20 μm Ni filter. An increment step of 0.05°0 and a rate of 1 step per 10 sec. were used. Samples were dried prior to experiment.

Scanning electron microscopy: An ultra-high resolution FE-SEM (Hitachi S-4800) employing a semi-in-lens design and a cold field emission electron source is used for micro-structural analysis. Prior to SEM observation, samples are vacuum dried and in order to suppress specimen charging during analysis, the specimen samples were coated with gold (2 nm thickness) using an Agar HR sputter coater.

Transmission electron microscopy: The samples for transmission electron microscopy (TEM) study were prepared embedding in epoxy polymer and the cured epoxies containing nanocomposite film strips were microtomed with a LKB Bromma 2088 ultramicrotome into 80-100 nm thickness for cross-sectional view. These slices were placed on a 200 mesh copper nets for TEM observation (JEOL-2000EX).

Mechanical testing: Tensile testing was performed on a Deben microtester with a load cell of 200 N. The films were cut in rectangular strips of dimensions 5 mm wide and 30 mm length. The gauge length was 10 mm and the extension rate was 0.5 mm/min.

Dynamic mechanical analysis (DMTA): DMTA measurements were performed on a dynamic mechanical analyzer (TA Instruments Q800) operating in tensile mode. Typical sample dimensions were 15×5×0.04 mm³. The measurement frequency and amplitude were kept at 1 Hz and 15 μm, respectively. At a nominal strain of 0.02%, temperature scan was made in the range 25-300° C. at a heating rate of 3° C. min⁻¹ under an air atmosphere.

Thermogravimetric analysis (TGA): The sample is accurately weighed (10 mg) into ceramic crucibles and the analysis is performed (Mettler Toledo TGA/SDTA851) under an oxygen flow of 55 ml/min, and at a heating rate of 10° C. min⁻¹. Change in the weight of the sample was recorded from the thermograms.

### Results and Discussion

1. Xyloglucan-MMT nanocomposite film characterization: Films with MMT content as high as 20% by dry weight (approx. 12 vol %) with high optical transparency were casted from xyloglucan-MMT composite solutions. For comparison, no data is available on polysaccharide nanocomposites with more than 10 wt % MMT added with adequate mechanical strength and toughness.¹⁸ For the most widely studied thermoplastic starch-MMT nanocomposites plasticizers (mostly polyol, glycerol for example) were added, to enhance the film forming properties, and the MMT dispersion and properties were perturbed by the plasticizer content.^{18, 20} It was highlighted that for glycerol content higher than 10 wt %, starch systems led to the formation of hybrid containing both organic and inorganic components, where glycerol is intercalated in the clay galleries instead of intercallating with starch macromolecules. On the other hand below 10 wt % of glycerol, starch systems undergo an “anti-plasticization” effect (films become more brittle).²¹ One advantage of xyloglucan MMT nanocomposite described herein lies in the fact that the material preparation was achieved without adding plasticizer.

X-ray diffraction (XRD) data and transmission electron microscopy (TEM) throws light upon dispersion state of the clay platelets in the xyloglucan-MMT nanocomposite matrix. XRD provides the most important parameter discerning the dispersion of MMT layers in the polymer matrix- the spacing between diffractional lattice planes. The so-called interlayer or gallery distance between the stacked layers for Na-MMT have been reported to be around 10 Å.⁹ The nanocomposite structure (intercalated or exfoliated) could be identified with intensity of the basal reflections from the distributed silicate layers. For an exfoliated nanocomposite, the extensive delamination of the silicate layers in the polymer matrix results in the eventual disappearance of any coherent X-ray diffraction from the distributed silicate layers. Generally for intercalated nanocomposites, the finite layer expansion associated with the polymer intercalation results in the appearance of a new basal reflection corresponding to the gallery height.¹⁴ TEM can be a useful tool to have a direct observation of the state of the platelets.

The XRD spectrum tentatively reveals that for MMT addition of 1 wt % and 2.5 wt %, the MMT platelets are completely exfoliated in the matrix polymer whereas for additions of 5 wt % or more, the silicate layers are delaminated and dispersed in a continuous polymer matrix with a constant interlayer spacing of 26 Å as shown by the lattice plane diffraction at d₀₀₁ of 36 Å (see FIG. 2). Further, the interlayer gallery spacing for the xyloglucan MMT nanocomposites is independent of the silicate loading. In effect, the kinetic constraints imposed by the polymer become less important as the MMT content increases above 5 wt %, and consequently, for higher amounts of MMT, intercalated clay tactoids are formed predominantly as predicted by thermodynamics.²² From diffraction theory, the scattering probability (or efficiency) increases with decreasing diffraction angle, which explains why the observed XRD intensity is so much larger for composite samples compared to the pure MMT sample, despite the lower clay concentration in the composite samples.²³ For a high molecular weight polymer such as xyloglucan, the interlayer expansion is very likely comparable to the radius of gyration of the polymer rather than that of extended chains.⁹

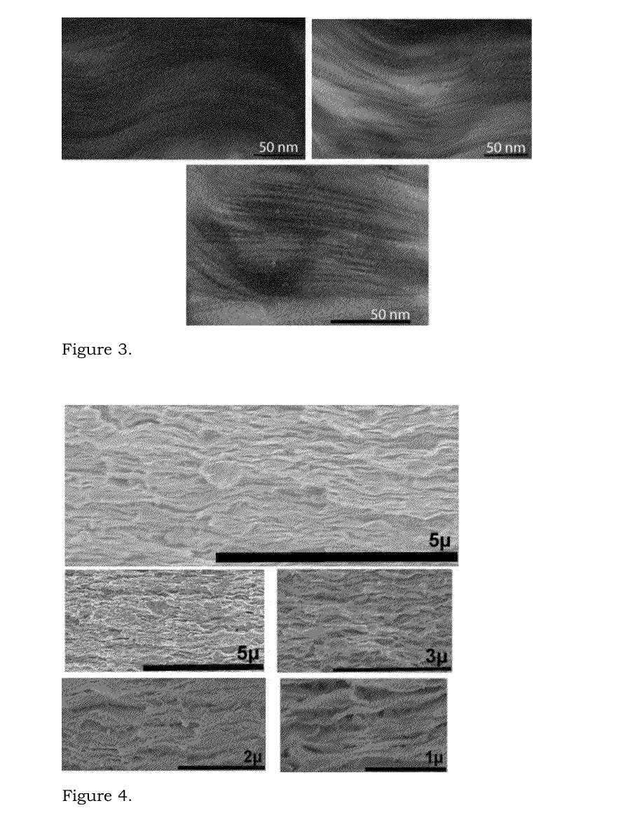

TEM allows a qualitative understanding of the internal structure by direct visualization. The TEM micrographs of a representative nanocomposite film with 10 wt % MMT is shown in FIG. 3. Dark lines correspond to the cross section of an MMT platelet ca. 1 nm thick and the gap between two adjacent lines is the interlayer spacing or gallery distance. Nanometer-range intercalated clay tactoids are clearly visible in FIG. 3. The basal spacing obtained by XRD and TEM are in good agreement, while the TEM reveals a part of MMT platelets are in exfoliated state.

SEM images (FIG. 4) of the cross-section of a nanocomposite containing 10 wt % MMT reveals a strikingly good alignment of the platelets. The SEM image of the cross-section reveals a layered structure which is conceptually similar to the multi-layered structures prepared by the so called layer-by-layer assembly (LBL).24

Thus the xyloglucan and montmorillonite are mixed at the molecular level forming a polymer-based molecular composite. In sub-ambient glass transition temperatures, there is a possible strain-induced alignment of the silicate layers in the amorphous xyloglucan under the constrained drying process used in the present study.²⁵

Tensile and thermo-mechanical properties: The tensile properties of the composites showed remarkable improvements for xyloglucan MMT nanocomposites (see FIG. 5 and table 5). The tensile strength increases from 93 to 123 MPa with 20 wt % MMT addition. There is three-fold increase in modulus for the same composition. Furthermore, the strain to failure is as high as 6.6% also at 5 wt % MMT content. Note that even at 10% MMT content, many samples showed strain-to-failure of the order of around 4%.

TABLE 5
Mechanical properties of XG-clay nanocomposites at 50% RH
and 23° C. (values in parentheses are standard errors).

| | Tensile strength, | Tensile strain | E-modulus, |
|---|---|---|---|
| Sample | MPa | at break, % | GPa |
| Xyloglucan | 92.9(5.8) | 8.87(2.0) | 4.1(0.15) |
| XG + 1% MMT | 89.1(6.9) | 15.5(2.9) | 5.1(0.53) |
| XG + 2.5% MMT | 96.2(6.7) | 12.2(1.7) | 5.9(0.1) |
| XG + 5% MMT | 103.9(2.7) | 6.6(1.9) | 6.2(0.48) |
| XG + 10% MMT | 114.3(6.3) | 3.8(1.2) | 8.6(0.26) |
| XG + 20% MMT | 123(7.4) | 2.1(0.31) | 11.6(1.7) |

The excellent mechanical properties of XG-clay nanocomposite can be considered to have their origin in an enormous surface area and hydrogen bonds between the matrix polymer and inorganic reinforcements due to the presence of large number of —OH groups. It has been shown previously that the modulus and strength of polymer nanocomposites with sub-ambient glass transition temperatures show substantial improvement and is attributed to a possible strain-induced alignment of the silicate layers.²⁵ In the intercalated state, the chain-segment immobility increases to certain extent under high content of MMT which results in decreased tensile strain observed for nanocomposites with more than 5 wt % MMT.

The thermo-mechanical properties of native xyloglucan and xyloglucan nanocomposites prepared with Na-MMT are presented in FIG. 6

The remarkable improvement in storage modulus observed for all nanocomposites in the temperature range studied indicates strong interaction between the matrix and MMT and hence mechanical reinforcement in elastic region.¹⁴ The tan δ peak at 260° C. (corresponds to glass transition temperature of native xyloglucan) is shifted to 278° C. for xyloglucan with 20 wt % MMT. Furthermore the greater increase in storage modulus at temperatures above the glass transition temperature of xyloglucan (260° C.) for all compositions implies an extended intercalation at softening temperature in addition to the mechanical reinforcement.^{14, 22} The tan δ peak envisage the fact that for 1 wt % MMT, there is greater degree of molecular mobility as noticed for the dramatic increase in tensile strain properties for the same composition (FIG. 5 and Table 5).

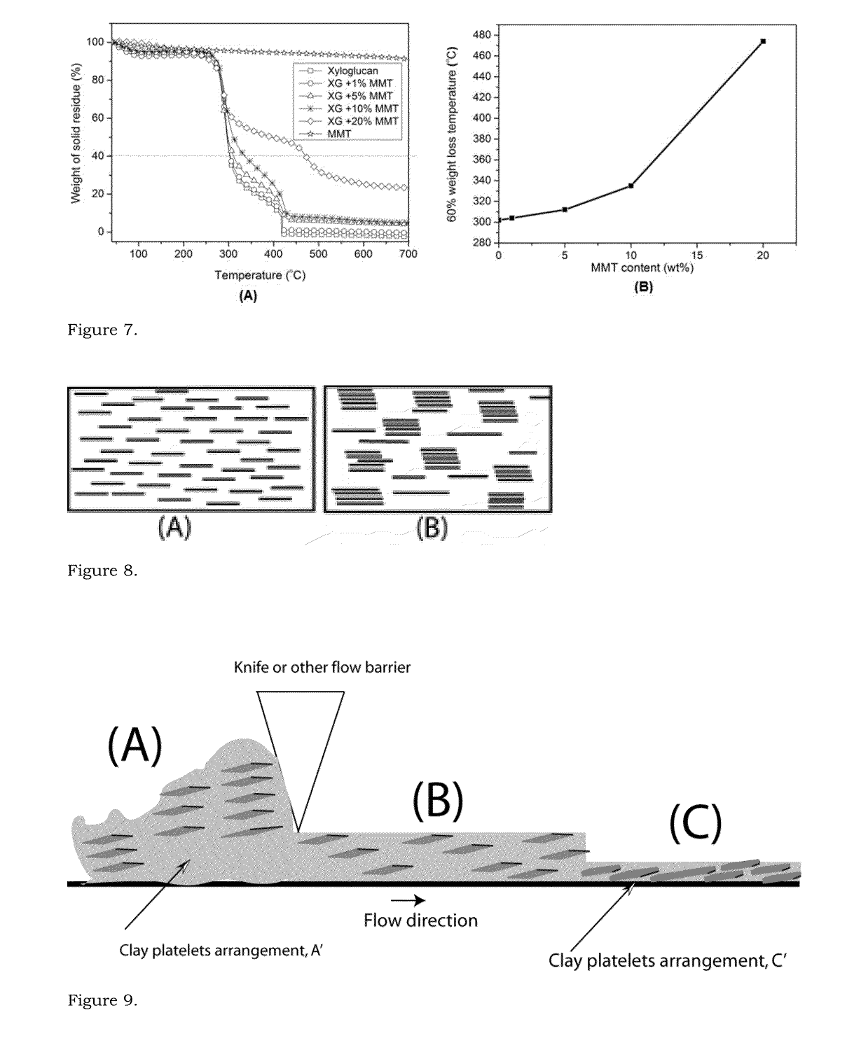

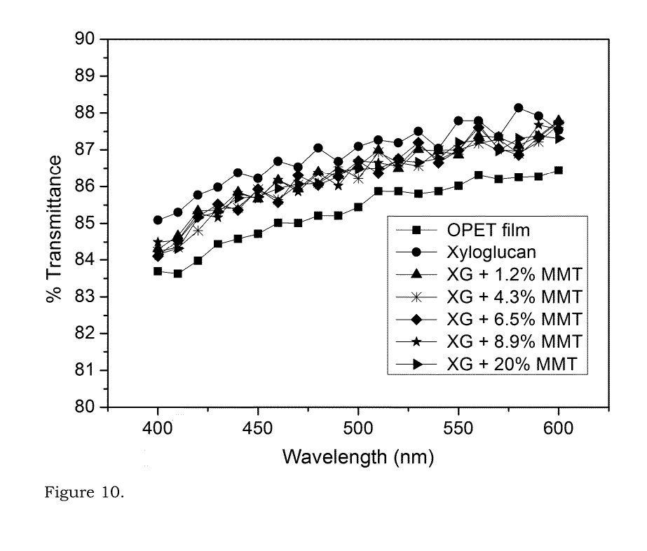

TGA curves of xyloglucan-MMT nanocomposites are shown in FIG. 7. Evidently, the thermal decomposition of nanocomposite materials shifted toward the higher temperature range than that of native xyloglucan, which points to the enhanced thermal stability of confined polymers. Above 500° C., all the curves become flat and mainly inorganic residue remained. Based on the TGA curves, the temperature at which 60% weight loss of the xyloglucan-MMT hybrid occurs increased from 302° C. to 474° C. with the addition of 20 wt % MMT, meaning that the thermal stability was tremendously increased as compared to the native xyloglucan. In the case of thermoplastic starch-MMT composites, it was reported that the increase in thermal stability is observed with the addition of the MMT only up to 5 wt % MMT, while the increase levelled off with further addition of MMT. Clearly, for starch-MMT systems, there was no molecular level mixing for the hybrids prepared with more than 5 wt % MMT. It is difficult to add as much as 20 wt % of clay to polysaccharides and this is a unique feature of xyloglucan-based nanocomposites which is advantageous for the thermal stability of the material.

Oxygen barrier properties: The oxygen permeability of the xyloglucan film under dry condition is 0.41 cc μm⁻² d⁻¹ kPa⁻¹ at 23° C. and average oxygen permeability at 50% RH and 23° C. was 2.3 cc μm⁻² d⁻kPa⁻¹, though, in one experiment, permeability has dropped to the level of 0.5 cc μm⁻² d⁻¹ kPa⁻¹ at 50% RH and 23° C. Xyloglucan has very low oxygen permeability and is comparable to the commercial barrier polymers such as poly(vinyl alcohol) and recently reported biopolymers such as wood hemicelluloses (see Table 6). The higher degree of polarity as a result of the presence of the large number of hydroxyl groups has a significant role in the effectiveness of these polymers as oxygen barriers.²⁷ For instance, substituting the nature of X group in the polymer —(CH₂−CHX)—ₙ from —H to —OH groups alone changes the oxygen permeability from 1867 cc μm m⁻² d⁻¹ kPa⁻¹ to 0.04 cc μm m⁻² d⁻¹ kPa⁻¹ .²⁷ The polar —OH groups induces an accumulation of electron density (dipole moment) at one end of non-polar O₂ molecule to result a dipole-dipole attraction, the mechanism by which O₂ dissolve in a polysaccharide such as xyloglucan. Other factors that contribute to the excellent oxygen barrier property of xyloglucan are the high chain stiffness as evidenced by the mechanical properties, the hydrogen bonding present between chains, and high glass transition temperature.

TABLE 6
Oxygen permeability of polymers measured at 23° C., 50% RH

| | | O₂ permeability | Reference and |
|---|---|---|---|
| Material | Plasticizer | (cc μm m⁻² d⁻¹ kPa⁻¹) | thickness |
| AcGGM | sorbitol | 2.0 | ²⁸ thickness = |
| | (21 wt %) | | 30-60μ |
| AcGGM- | — | 1.3 | ²⁸ thickness = |
| CMC | | | 30-60μ |
| amylopectin | glycerol | 14 | ²⁹ thickness = |
| | (40 wt %) | | 70-100μ |
| poly(lactic | — | 160 | Present study, |
| acid) | | | thickness = 100μ |
| poly(vinyl | — | 0.21 | ³⁰ thickness = 35μ |
| alcohol) | | | |
| xylan | sorbitol | 0.21 | ³⁰ thickness = 35μ |
| | (35 wt %) | | |
| Xyloglucan | — | 2.3 | Present study, |
| | | | thickness = 10-15μ |

Nevertheless, the major concern with polysaccharides and poly(vinyl alcohol) is the high water sensitivity, which means that oxygen permeability becomes very high at high humidity. For instance, the oxygen permeability of native xyloglucan increased by a factor of more than 5 when exposed to a humidity of 50% RH from dry condition. The reason is that xyloglucan and other hemicelluloses swell in presence of moisture so that the close chain-to-chain packing ability is lessened.

Except for a 15% nominal decrease in oxygen permeability noticed for xyloglucan-20 wt % MMT freestanding films, the oxygen barrier studies show the fact that MMT dispersion does not affect the permeability of the native xyloglucan to a large degree.

The permeability in filled polymers is generally described by a simple model known as Nielson model based on tortuous path for a penetrant gas.³¹ The effect of tortuousity on the

$$\frac{Ps}{pp} = \frac{1}{1 + ( L / 2 W ) ϕ s}$$

permeability is expressed as a function of the length (L) and width of the sheets (W), as well as their volume fraction in the polymer matrix (φs) as, Equation 1,:

where Ps and Pp represent the permeabilities of the polymer-silicate nanocomposite and pure polymer, respectively. The model makes a key assumption that the sheets are placed normal to the direction of diffusion and is fully delaminated and dispersed as shown in FIG. 8 A.

2. Coatings based on xyloglucan-MMT nanocomposites:

Coating on OPET film:

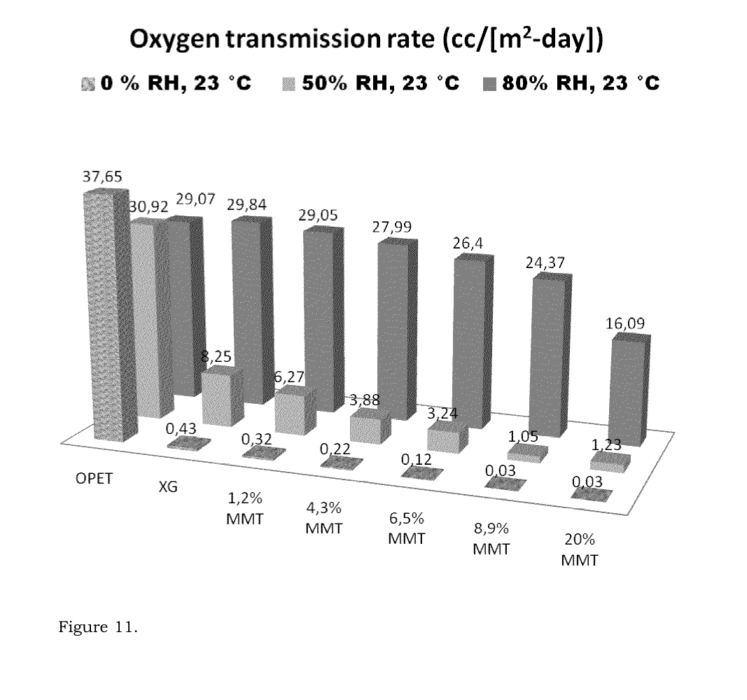

The oxygen transmission rate data for different xyloglucan-MMT nanocomposites compositions are presented in FIG. 11.

The oxygen transmission rate was steadily decreasing with increasing MMT content and at 10 wt % addition of MMT, there is 100% decrease at 0% RH and 90% decrease at 50% RH. Even at 80% RH, there is approximately 45% reduction in oxygen transmission rate for a nanocomposite containing 20wt % of MMT.

To render the oxygen barrier data more comparable, the oxygen permeability for each coating were calculated using the relationship^{27, 34}:

$$\frac{1}{ptotal} = \frac{ts}{tPs} + \frac{tc}{tPc} \qquad ( 2 )$$

Where Ptotal is total permeability of the laminate and Ps and Pc are the permeabilities of the substrate and coating respectively. The thickness of the coating and the substrate films are t_{c} and tₛ respectively so that the total thickness of the laminate is t. The calculated oxygen permeability of the nanocomposites is given in table 7.

TABLE 7
Oxygen permeability of XG/MMT nanocomposite films (cc · μm/[m² · day]kPa⁻¹). The
standard deviation values are given in parenthesis.

| | | XG + 1.2% | XG + 4.3% | XG + 6.5% | XG + 8.9% | XG + 20% |
|---|---|---|---|---|---|---|
| Condition | XG | MMT | MMT | MMT | MMT | MMT |
| 0% RH, | 0.02 | 0.01 | 0.01 | 0.01 | 0.00 | 0.00 |
| 23° C. | (0.001) | (0.001) | (0.000) | (0.000) | (0.000) | (0.000) |
| 50% RH, | 0.45 | 0.31 | 0.18 | 0.14 | 0.04 | 0.05 |
| 23° C. | (0.004) | (0.006) | (0.009) | (0.003) | (0.001) | (0.000) |
| 80% RH, | — | — | 30.14 | 11.50 | 6.03 | 1.44 |
| 23° C. | | | (0.005) | (0.022) | (0.021) | (0.004) |

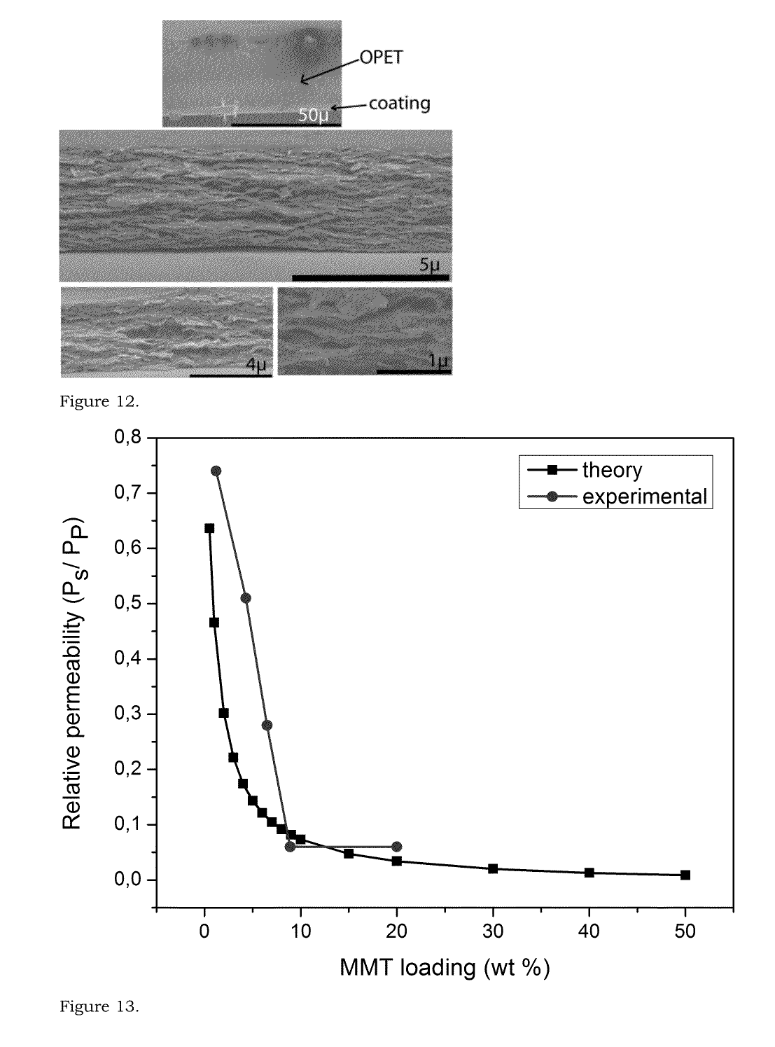

Cross-sectional views in SEM reveal that the MMT platelets are oriented parallel to the substrate film (see FIG. 12). What makes it different from the orientation of silicate sheets in the free-casted xyloglucan MMT nanocomposites film is that the intercalated MMT tactoids are more separated laterally assisted by the shear forces of the coating process and the self-ordering of the high-aspect ratio nanoclays. The MMT sheets are oriented in an ideal way as shown in FIG. 8A to increase the tortuous path for oxygen diffusion. This is an advantage and explains why the barrier properties are so good for xyloglucan-MMT nanocomposites coated on OPET.

The relative permeability of xyloglucan nanocomposites in comparison with native xyloglucan calculated using Nielson model (equation 1) with a fitting factor of L=425 nm and W=1 nm is shown in FIG. 13 as a function of the concentration of MMT in the matrix. The relative permeability for xyloglucan nanocomposites obtained from the present investigation is represented alongside. It is to be noted that the decrease in permeability leveled off at around 10 wt % MMT content.

Uniform and transparent coatings of 4μ thickness were made on an OPET film of thickness 36μ. The UV-visible light absorption spectrum of the films showed high transmittance in the range from 400 to 600 cm⁻¹. All coatings including the coating with native xyloglucan increases the optical transparency of OPET film, probably by filling the micro-voids on OPET surface.³³

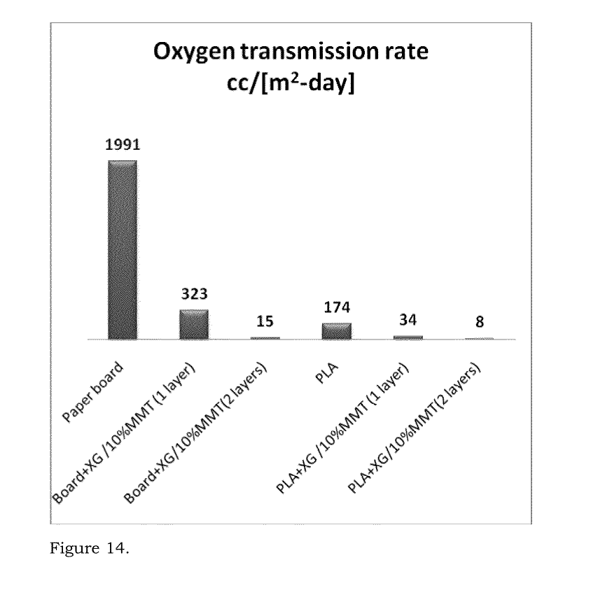

Coating on paper board and PLA film: The compatibility of xyloglucan and cellulose is evidenced from Mother Nature, where xyloglucan is a structural polysaccharide in the primary cell wall of plants in close association with cellulose nanofibers. The non-electrostatic interaction of xyloglucan and cellulose was used in the preparation of multi-layers in a recent study.³⁵ Paper board is an integral part of many packaging structures, where it provides the necessary mechanical rigidity to the structure. Similarly, poly (lactic acid) is considered to be one of the important biopolymers of tremendous potential. However, on the other hand, both paper board and PLA have very low oxygen barrier performance that limits their application in packaging. A representative xyloglucan nanocomposite solution containing 10 wt % MMT was successfully coated over paper board and PLA. It was proved in the present investigation that a xyloglucan-MMT nanocomposite coating over plasma activated PLA surface could successfully make it a barrier film. The relative decrease of oxygen transmission is obvious from FIG. 14. Multilayering of xyloglucan-MMT nanocomposite layers in the coating further reduced the oxygen transmission rate as is also seen in FIG. 14.

In the case of paper board, with a single layer coating of xyloglucan-clay composite, there is 85% reduction in oxygen transmission and with a double layer xyloglucan-clay composite coating, it is observed more than 99% reduction in oxygen transmission. Similarly for PLA film, there is more than 95% decrease in the oxygen transmission rate with two thin layers of xyloglucan nanocomposite coating.

### REFERENCES

1. Brody, A. L.; Bugusu, B.; Han, J. H.; Sand, C. K.; McHugh, T. H., Innovative food packaging solutions. Journal of Food Science 2008, 73, (8), R107-R116.
2. Miller, K. S.; Krochta, J. M., Oxygen and aroma barrier properties of edible films: A review. Trends in Food Science & Technology 1997, 8, (7), 228-237.
3. Petersen, K.; Nielsen, P. V.; Bertelsen, G.; Lawther, M.; Olsen, M. B.; Nilsson, N. H.; Mortensen, G., Potential of biobased materials for food packaging. Trends in Food Science & Technology 1999, 10, (2), 52-68.
4. Gandini, A., Polymers from Renewable Resources: A Challenge for the Future of Macromolecular Materials. Macromolecules 2008, 41, (24), 9491-9504.
5. Hansen, N. M. L.; Plackett, D., Sustainable films and coatings from hemicelluloses: A review. Biomacromolecules 2008, 9, (6), 1493-1505.
6. Hartman, J.; Albertsson, A. C.; Sjoberg, J., Surface- and bulk-modified galactoglucomannan hemicellulose films and film laminates for versatile oxygen barriers. Biomacromolecules 2006, 7, (6), 1983-1989.
7. Edlund, U.; Ryberg, Y. Z.; Albertsson, A. C., Barrier Films from Renewable Forestry Waste. Biomacromolecules 2010, 11, (9), 2532-2538.
8. Kochumalayil, J.; Sehaqui, H.; Zhou, Q.; Berglund, L. A., Tamarind seed xyloglucan—a thermostable high-performance biopolymer from non-food feedstock. Journal of Materials Chemistry 2010, 20, (21), 4321-4327.
9. Giannelis, E. P., Polymer layered silicate nanocomposites. Advanced Materials 1996, 8, (1), 29-&.
10. Ray, S. S.; Okamoto, M., Polymer/layered silicate nanocomposites: a review from preparation to processing. Progress in Polymer Science 2003, 28, (11), 1539-1641.
11. Thostenson, E. T.; Li, C. Y.; Chou, T. W., Nanocomposites in context. Composites Science and Technology 2005, 65, (3-4), 491-516.
12. Okada, A.; Usuki, A., Twenty years of polymer-clay nanocomposites. Macromolecular Materials and Engineering 2006, 291, (12), 1449-1476.
13. Okada, A.; Usuki, A., The chemistry of polymer-clay hybrids. Materials Science & Engineering C-Biomimetic Materials Sensors and Systems 1995, 3, (2), 109-115.
14. Ray, S. S.; Bousmina, M., Biodegradable polymers and their layered silicate nano composites: In greening the 21st century materials world. Progress in Materials Science 2005, 50, (8), 962-1079.
15. Avella, M.; De Vlieger, J. J.; Errico, M. E.; Fischer, S.; Vacca, P.; Volpe, M. G., Biodegradable starch/clay nanocomposite films for food packaging applications. Food Chemistry 2005, 93, (3), 467-474.
16. Park, H. M.; Lee, W. K.; Park, C. Y.; Cho, W. J.; Ha, C. S., Environmentally friendly polymer hybrids-Part I-Mechanical, thermal, and barrier properties of thermoplastic starch/clay nanocomposites. Journal of Materials Science 2003, 38, (5), 909-915.
17. Ray, S. S.; Yamada, K.; Okamoto, M.; Ueda, K., Polylactide-layered silicate nanocomposite: A novel biodegradable material. Nano Letters 2002, 2, (10), 1093-1096.
18. Chivrac, F.; Pollet, E.; Averous, L., Progress in nano-biocomposites based on polysaccharides and nanoclays. Materials Science & Engineering R-Reports 2009, 67, (1), 1-1
19. Rhim, J. W.; Ng, P. K. W., Natural biopolymer-based nanocomposite films for packaging applications. Critical Reviews in Food Science and Nutrition 2007, 47, (4), 411-433.
20. Chivrac, F.; Pollett, E.; Schmutz, M.; Averous, L., New approach to elaborate exfoliated starch-based nanobiocomposites. Biomacromolecules 2008, 9, (3), 896-900.
21. Lourdin, D.; Bizot, H.; Colonna, P., “Antiplasticization” in starch-glycerol films? Journal of Applied Polymer Science 1997, 63, (8), 1047-1053.
22. Vaia, R. A.; Giannelis, E. P., Lattice model of polymer melt intercalation in organically-modified layered silicates. Macromolecules 1997, 30, (25), 7990-7999.
23. Krumm, S., Simulation of XRD patterns from oriented clay minerals by WinStruct. Computers & Geosciences 1999, 25, (4), 501-509.
24. Tang, Z. Y.; Kotov, N. A.; Magonov, S.; Ozturk, B., Nanostructured artificial nacre. Nature Materials 2003, 2, (6), 413-U8.
25. Lan, T.; Pinnavaia, T. J., CLAY-REINFORCED EPDXY NANOCOMPOSITES. Chemistry of Materials 1994, 6, (12), 2216-2219.
26. Park, H. M.; Li, X. C.; Jin, C. Z.; Park, C. Y.; Cho, W. J.; Ha, C. S., Preparation and properties of biodegradable thermoplastic starch/clay hybrids. Macromolecular Materials and Engineering 2002, 287, (8), 553-558.
27. Ashley, R. J., Polymer Permeability. Elsevier Science Publishing co. Inc.: Essex, 1985.
28. Hartman, J.; Albertsson, A. C.; Lindblad, M. S.; Sjoberg, J., Oxygen barrier materials from renewable sources: Material properties of softwood hemicellulose-based films. Journal of Applied Polymer Science 2006, 100, (4), 2985-2991.
29. Rindlav-Westling, A.; Stading, M.; Hermansson, A. M.; Gatenholm, P., Structure, mechanical and barrier properties of amylose and amylopectin films. Carbohydrate Polymers 1998, 36, (2-3), 217-224.
30. Grondahl, M.; Eriksson, L.; Gatenholm, P., Material properties of plasticized hardwood Xylans for potential application as oxygen barrier films. Biomacromolecules 2004, 5, (4), 1528-1535
31. Nielsen, L. E., Models for the permeability of filled polymer systems. Journal of Macromolecular science (Chem.) 1967, A1, (5), 929-942.
32. Bharadwaj, R. K., Modeling the barrier properties of polymer-layered silicate nanocomposites. Macromolecules 2001, 34, (26), 9189-9192.
33. Nogi, M.; Iwamoto, S.; Nakagaito, A. N.; Yano, H., Optically Transparent Nanofiber Paper. Advanced Materials 2009, 21, (16), 1595-+.
34. Lange, J.; Stenroos, E.; Johansson, M.; Malmstrom, E., Barrier coatings for flexible packaging based on hyperbranched resins. Polymer 2001, 42, (17), 7403-7410.
35. Jean, B.; Heux, L.; Dubreuil, F.; Chambat, G.; Cousin, F., Non-Electrostatic Building of Biomimetic Cellulose-Xyloglucan Multilayers. Langmuir 2009, 25, (7), 3920-3923.

1. A coating comprising a layer of a film comprising xyloglucan and clay.

2. The coating of claim 1 wherein the clay is sodium-montmorillonite (MMT).

3. The coating according to claim 1 wherein the clay content is 1 to 30 wt %, for example 1 wt % or more, or 3 wt % or more, or 5 wt % or more, or 10 wt % or more, or 30 wt % or less, or 25 wt % or less or 20 wt % or less, or 15 wt % or less, or 12 wt % or less.

4. The coating according to claim 1 wherein the clay content is 10-20 wt %.

5. The coating according to claim 1 wherein the sheets of the clay are oriented substantially parallel with the film.

6. The coating according to claim 1 wherein the film does not comprise a plasticizer.

7. The coating according to claim 1 wherein the film consists of xyloglucan and clay.

8. The coating according to claim 1 wherein the coating comprises two or more layers of the film.

9. The coating according to claim 1 wherein the coating has an elastic modulus of at least 6 GPa and a tensile strength of at least 100 MPa when measured at 50% RH at 23° C.

10. The coating according to claim 1 wherein the coating has an oxygen permeability of 0.2 cc.μm/[m2.day]kPa−1 or less when measured at 50% RH at 23° C.

11. A paperboard comprising a coating of claim 1.

12. A moulded fiber product comprising a coating of claim 1.

13. A polymeric material comprising a coating of claim 1.

14. The coated polymeric material of claim 13 wherein the polymer is a polyester.

15. The coated polymeric material of claim 13 wherein the polymer is an oriented polyester.

16. A film comprising xyloglucan and 20 wt % of clay.

17. A method of coating a substrate with the coating of claim 1 comprising the steps:
a. Providing a substrate;
b. Optionally activating the surface of the substrate;
c. Providing a dispersion of xyloglucan and clay;
d. Applying the dispersion to the substrate;
e. Spreading the dispersion across the substrate by applying a shear force to the dispersion;
f. Optionally, applying pressure to the applied dispersion; and
g. Drying the coating;
h. Optionally repeating the steps d to g.

18. The method of claim 17 wherein the spreading is done using a knife, rod, blade or a wire.

19. A coating obtainable by the method of claim 17.

20.-22. (canceled)

23. A coating according to claim 1 wherein the molecular weight of the xyloglucan is in the range of 10,000 to 500,000 g/mol, or more preferably 30,000 to 500,000 g/mol or even more preferably 100,000 to 300,000 g/mol.
